(19) United States
(12) Patent Application Publication
(10) Pub. No.: US 2026/0351782 A1
(43) Pub. Date: Nov. 5, 2026

(54) Battery pack with closable ventilation openings and method for charging a battery pack with closable ventilation openings

(71) Applicant: Andreas Stihl AG & Co. KG, Waiblingen (DE)

(72) Inventors: Joachim Kolb, Weinstadt (DE); Christian Uhlmann, Erlangen (DE); Florian Klein, Esslingen am Neckar (DE); Michael Fuchs, Waiblingen (DE)

(73) Assignee: Andreas Stihl AG & Co. KG, Waiblingen (DE)

(21) Appl. No.: 19/636,133

(22) Filed: Apr. 1, 2026

(30) Foreign Application Priority Data
Apr. 7, 2025 (DE) 102025113626.2

(51) Int. Cl. H01M 50/333; H01M 10/44; H01M 10/48; H01M 10/613; H01M 10/6563; H01M 50/204; H02J 7/70

(52) U.S. Cl. CPC H01M 50/333; H01M 10/44; H01M 10/486; H01M 10/613; H01M 10/6563; H01M 50/204; H02J 7/70

(57) ABSTRACT

A battery pack has a receiving space bounded by a housing wall, and a cell assembly made up of individual cells is received in the receiving space. At least one ventilation opening for entry and/or exit of an air flow for temperature conditioning of the cell assembly is formed in at least one housing wall of the receiving space. A closure element is assigned to the ventilation opening. In a closed position, the closure element closes the ventilation opening to block entry and/or exit of the air flow. In an open position, the closure element opens the ventilation opening to allow entry and/or exit of the air flow.

### CROSS-REFERENCE TO RELATED APPLICATION

This application claims the benefit of German Patent Application DE 102025113626.2, filed on Apr. 7, 2025, the entire contents of which is incorporated by reference.

### TECHNICAL FIELD

The disclosure relates to a battery pack having a receiving space, which is bounded by a housing wall, for a cell assembly made up of individual cells. For controlling the temperature of the cell assembly in the receiving space by an air flow, at least one ventilation opening for the entry and/or exit of an air flow is provided in the housing wall.

### BACKGROUND

Battery packs of the described construction are also used in environments heavily exposed to dirt, wherein dirt can enter the receiving space via a provided ventilation opening in the housing wall for controlling the temperature of the cell assembly. In addition, it cannot be ruled out that the ventilation opening becomes clogged by dirt, so that temperature conditioning of the cell assembly by an air flow is impeded or becomes impossible.

### SUMMARY

A battery pack may include a cell assembly made up of individual cells received in a receiving space. In some configurations, the battery pack is configured to largely prevent dirt from penetrating into the receiving space while allowing temperature conditioning of the cell assembly by an air flow.

The battery pack may include a receiving space bounded by a housing wall and a ventilation opening in the housing wall. A closure element may be assigned to the ventilation opening. In a closed position, the closure element closes the ventilation opening to block entry and/or exit of an air flow. In an open position, the closure element opens the ventilation opening to allow entry and/or exit of the air flow.

Since the cell assembly in the receiving space of the battery pack can heat up, in particular during charging or discharging in a device, in particular in a charger or a power tool, or can already be inserted into the receiving space in a heated state, the ventilation opening is opened or held open during the charging operation in the device and is closed or held closed outside the device. It is thereby ensured, on the one hand, that temperature conditioning of the cell assembly with the air flow is ensured during the charging operation and, on the other hand, that outside the device, for example during operation of a power tool with the battery pack in a dirty environment, the risk of dirt entering the receiving space is reduced.

The closure element can be acted upon with a closing force, in particular with a spring force. The closing force, in particular the spring force, holds the closure element in the closed position, so that the ventilation opening is closed. The configuration can be such that, after insertion of the battery pack into the device, the closure element holds the ventilation opening open against a closing force. If the battery pack is removed from the device, the closure element closes the ventilation opening under the effect of the closing force. It is thereby ensured that the ventilation opening is closed outside the device and that, during a charging operation in the device, the closure element is in an open position, so that the ventilation opening is opened for the entry and/or the exit of the air flow.

One or more further ventilation openings can be formed for the entry and/or exit of a further air flow. The closure element can also be assigned to the further ventilation opening for the entry and/or the exit of the further air flow. The closure element then also closes the further ventilation opening for the entry and/or the exit of the further air flow in the closed position and also opens the further ventilation opening for the entry and/or the exit of the further air flow in the open position. Both the at least one ventilation opening and the further ventilation opening can thus be opened or closed by a common closure element. It can also be expedient to assign a respective closure element to the at least one ventilation opening, the further ventilation opening, and optionally further additional ventilation openings.

A closure element for closing or opening one or more ventilation openings can be formed as a slider or also as a flap pivotable about an axis or as a rotatable louver blade. It can also be expedient to form the closure element as a louver or as a shutter.

Structurally, the closure element or a plurality of closure elements, wherein each of the plurality of closure elements can be assigned to one or more ventilation openings, can be arranged on the inner side of the housing wall. It can also be expedient to provide one or more of these closure elements on the outer side of the housing wall. In a particular embodiment, one of these closure elements can be arranged in a ventilation opening. This one of the closure elements, in particular a joint of a pivotable flap, or a louver blade of this closure element, can lie between the outer side of the housing wall and the inner side of the housing wall.

The ventilation opening and/or the further ventilation opening and/or the above-mentioned plurality of ventilation openings can be provided in a fixed location in the housing wall. The closure element or the respective closure elements can each be movable relative to the ventilation opening or the ventilation openings to which they are respectively assigned. To actuate the closure element or the closure elements, an actuating device having a force source for providing an actuating force can be provided. The actuating device is configured to move, with the actuating force, the closure element or the closure elements into an open position in order to open the respectively assigned ventilation opening. The actuating force of a force source can also be provided to move the closure element or the closure elements into a closed position. The actuating force can act as an opening force or as a closing force.

The force source and/or the actuating device can be coupled to a temperature sensor or can be formed by a temperature element in order to exert a closing force on the closure element or the closure elements when a limit temperature is undershot, and to exert an opening force on the closure element or the closure elements when the limit temperature is exceeded. If the battery pack is charged in a device and the temperature rises above an upper limit temperature, an actuating force for opening the closure element or the closure elements is exerted by means of the force source. If the temperature falls below a lower limit temperature, the force source applies the actuating force for closing the ventilation opening or the ventilation openings. The upper limit temperature and the lower limit temperature can have different values, so that a predeterminable hysteresis is formed in order to avoid excessively frequent opening and closing of the closure element or the closure elements.

For effective temperature conditioning of the cell assembly in the receiving space of the battery pack, a ventilation opening for the exit of the air flow from the receiving space can be assigned to a ventilation opening, for the entry of an air flow into the receiving space. This assigned ventilation opening can advantageously lie opposite the ventilation opening for the entry of an air flow. In particular, a ventilation opening for the entry of an air flow lies in a first housing wall of the receiving space, and an assigned ventilation opening for the exit of the air flow lies in the opposite second housing wall of the receiving space.

In a device, in particular a charger or a power tool, for charging and/or discharging a battery pack having one or more of the features described above, a receptacle for inserting the battery pack can be formed on the device. A means for adjusting the closure element or the closure elements into their open position can be provided.

In particular, the means can be a mechanical actuating stop that can cooperate with the actuating device for actuating the closure element or the closure elements in order to hold the closure element or the closure elements in their respective open position. When the battery pack is inserted into the receptacle of the device, the closure element or the closure elements are adjusted into their respective open positions.

In a method for charging and/or discharging a battery pack according to one or more of the features described above, the battery pack is inserted into a receptacle of a device, in particular of a charger or an electric working device. In this process, the battery pack is aligned with an actuating stop of the device. Upon insertion of the battery pack into the receptacle, the actuating stop exerts a reaction force on a counter-stop on the battery pack in order thereby to exert an actuating force on the closure element or the closure elements. At least one closure element of a ventilation opening is moved into its open position by the stop. In the fully inserted position of the battery pack in the receptacle, the actuating stop holds the closure element or the closure elements in an open position.

In a method for charging and/or discharging a battery pack according to one or more of the features described above, the cooling air flow of a cooling fan provided in a device as described above can be used as a force source for moving the closure element or the closure elements into their open position. The battery pack is inserted into the receptacle of the device such that a ventilation opening of the battery pack is connected to a cooling-air outlet opening of the device, or is at least partially aligned therewith. The cooling air flow supplied or discharged via the cooling-air outlet opening of the device exerts an actuating force on the closure element, which is in particular formed as a flap pivotable about an axis, or on the closure elements of the ventilation opening of the battery pack, which are in particular likewise formed in this manner. The cooling air flow can move the closure element or the closure elements, in particular the flaps or louver blades, into the open position. In this case, one or more locking elements can be provided in order to secure the closure element or the closure elements against unintended adjustment, for example when the battery pack is not located in the device. Over at least part of the charging and/or discharging time of the battery pack, the cooling air flow of the device holds open the ventilation opening or the ventilation openings to the receiving space of the battery pack.

In a method for charging and/or discharging a battery pack according to one or more of the features described above, a closing force can be exerted on the closure element or the closure elements when a limit temperature is undershot and an opening force can be exerted on the closure element or the closure elements when the limit temperature is exceeded. The cell assembly made up of individual cells in the receiving space can thereby be optimally temperature-conditioned during the charging and/or discharging operation.

Exemplary embodiments of the invention are illustrated in the drawings.

### BRIEF DESCRIPTION OF THE DRAWINGS

FIG. 1 shows, in a schematic illustration, a battery pack having ventilation openings formed in its housing wall, which ventilation openings are closable by closure elements,

FIG. 2 shows, in a schematic illustration, a view of a housing wall of the battery pack with closure elements shifted into the open position and with opened ventilation openings,

FIG. 3 shows, in a schematic illustration, a battery pack having a louver as a closure element for a plurality of ventilation openings in the housing wall,

FIG. 4 shows a schematic illustration according to FIG. 3 with the ventilation openings open and the louver, as the closure element, in the open position,

FIG. 5 shows a schematic illustration of a housing wall of a battery pack having ventilation openings that can be closed and opened by closure elements configured as shutters,

FIG. 6 shows, in a schematic illustration, a device having a cooling fan and a battery pack inserted into a receptacle of the device,

FIG. 7 shows, in a schematic illustration, the device having a cooling fan according to FIG. 6, with closure elements to be adjusted into their open position by the cooling air flow of the cooling fan.

### DETAILED DESCRIPTION

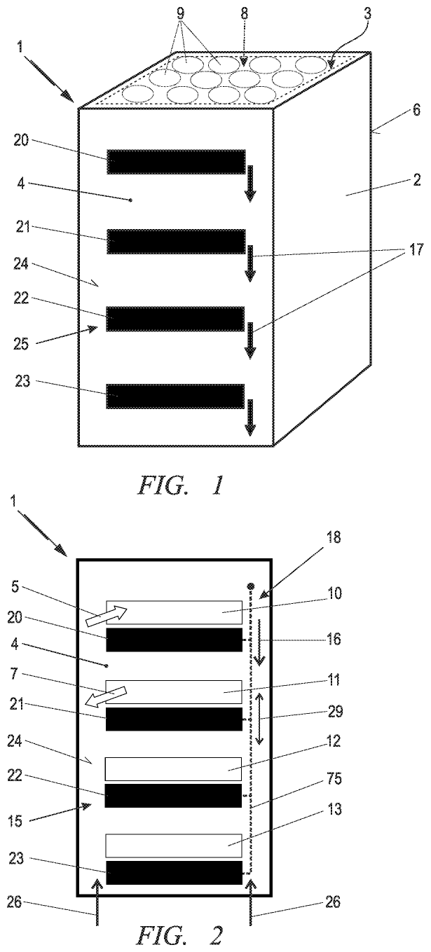

In FIG. 1, a battery pack 1 having a housing 2 is illustrated schematically. Housing walls 4, 6 of the housing 2 bound a receiving space 3 of the battery pack 1. A cell assembly 8 made up of individual cells 9 is received in the receiving space 3.

As FIG. 2 shows, at least one ventilation opening 10 for the entry and/or exit of an air flow 5, 7 is formed in the housing wall 4 of the housing 2. The cell assembly 8 arranged in the receiving space 3 can be temperature-conditioned with the air flow 5, 7. In the exemplary embodiment according to FIGS. 1 and 2, a plurality of ventilation openings 10, 11, 12 and 13, in particular four ventilation openings 10, 11, 12 and 13, are provided.

At least one ventilation opening 10, 11, 12 or 13 is assigned a closure element 20, 21, 22 or 23. In the closed position 25 of the closure element or of the closure elements 20, 21, 22 or 23 shown in FIG. 1, the assigned ventilation opening 10, 11, 12 or 13 is closed for the entry and/or the exit of the air flow 5, 7. In the open position 15 of the closure element or of the closure elements 20, 21, 22 or 23 shown in FIG. 2, the assigned ventilation opening 10, 11, 12 or 13 is opened for the entry and/or the exit of the air flow 5, 7.

As illustrated in FIG. 1, the closure element or the closure elements 20, 21, 22 or 23 are formed as sliders. The closure element or the closure elements 20, 21, 22 or 23 are shifted from the closed position 25 according to FIG. 1 with an opening force 16 in the direction of arrow 17 into the open position 15 according to FIG. 2. For this purpose, a means for adjusting the closure elements 20, 21, 22, 23 into their open position 15 is provided.

As a means for adjusting one or more of the closure elements 20, 21, 22, 23, FIG. 2 shows an actuating device 18 that can be formed as a linkage 75. The actuating device 18 is coupled in each case to a closure element 20, 21, 22 and 23. Via the linkage 75 of the actuating device 18, the closure elements 20, 21, 22 and 23 are to be adjusted together under the effect of an actuating force 29 from their open position 15 (FIG. 2) into their closed position 25 (FIG. 1) and from their closed position 25 into their open position 15.

One or more of the closure elements 20, 21, 22 or 23 is/are pretensioned with a closing force 26 (FIG. 2) into the closed position 25 according to FIG. 1. The closing force 26 is preferably a spring force. A pneumatic force or the like can also be provided as the closing force 26. The closure elements 20, 21, 22 or 23 are held in their closed position 25 by the closing force 26.

All closure elements 20, 21, 22 and 23 can be adjusted individually, but in particular together. The closure elements 20, 21, 22 and 23 are in particular mechanically coupled to one another in order to ensure a common movement of all closure elements 20, 21, 22 and 23.

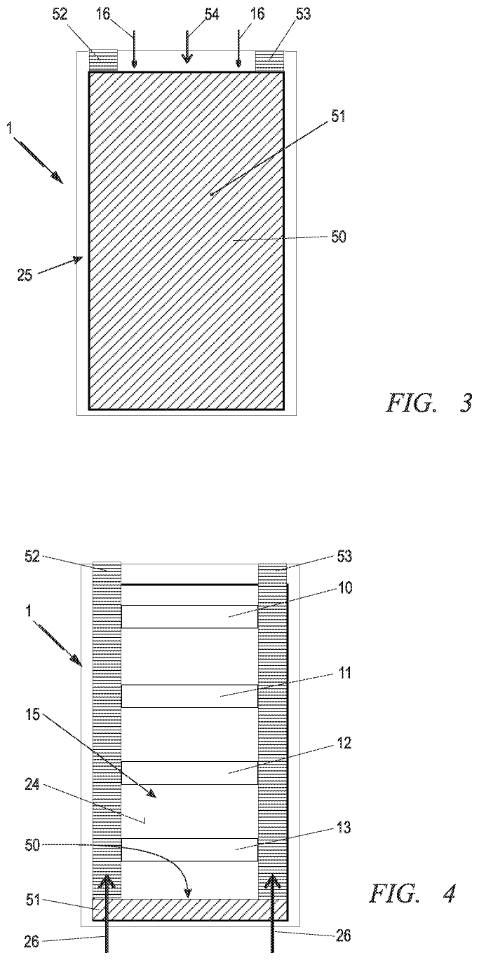

As illustrated in FIGS. 3 and 4, the ventilation openings 10, 11, 12 or 13 can be opened or closed by a common closure element 50. In FIG. 3, a louver 51 is provided as the common closure element 50. By way of at least one spring, in the exemplary embodiment by way of two spring bands 52 and 53, the closure element 50 formed as the louver 51 is pretensioned with a closing force 26 into the closed position 25 according to FIG. 3. To open the ventilation openings 10, 11, 12, 13, the louver 51 is to be shifted against the closing force 26 of the spring bands 52, 53 in the direction of arrow 54 (FIG. 3) with an opening force 16 from the closed position 25 into the open position 15 (FIG. 4). In the open position 15 (FIG. 4), all ventilation openings 10, 11, 12, 13 can be open.

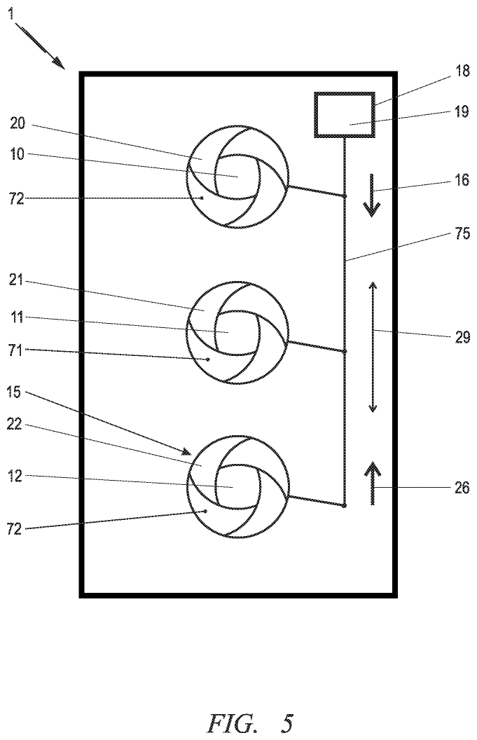

In the exemplary embodiment according to FIG. 5, the ventilation openings 10, 11 and 12 are respectively assigned closure elements 20, 21 and 22, which can be formed as adjustable shutters 70, 71 and 72. A shutter 70, 71, 72 can have a plurality of louver blades; in the exemplary embodiment shown, a shutter 70, 71, 72 is configured in each case with four louver blades.

In order to change the cross section of the ventilation openings 10, 11, 12, the shutters 70, 71, 72 can be adjusted individually and independently of one another by way of a means. In the exemplary embodiment shown according to FIG. 5, the shutters 70, 71, 72 can, for example, be adjusted together by way of an actuating element 28. The actuating element 28 can comprise a linkage 75 and is actuated by an actuating device 18 that comprises a force source 19. The force source 19 acts with an actuating force 29 on the actuating element 28. The actuating device 18 is configured as a means for moving, with the actuating force 29, a closure element 20, 21, 22 or a shutter 70, 71, 72 into an open position 15 or a closed position.

The force source 19 can be formed by a temperature element or can be coupled to a temperature element or temperature sensor in order to exert a closing force 26 on the closure elements 20, 21, 22 when a limit temperature is undershot. When the limit temperature is exceeded, an opening force 16 is exerted on the closure elements 20, 21, 22. If the temperature rises above an upper limit temperature, an opening force 16 for opening the closure elements 20, 21, 22 is applied by means of the force source 19. If the temperature falls below a lower limit temperature, the force source 19 applies a closing force 26 for closing the ventilation openings 10, 11, 12. The upper limit temperature and the lower limit temperature can have different values, so that a predeterminable hysteresis is formed in order to avoid excessively frequent opening and closing of the closure elements 20, 21, 22.

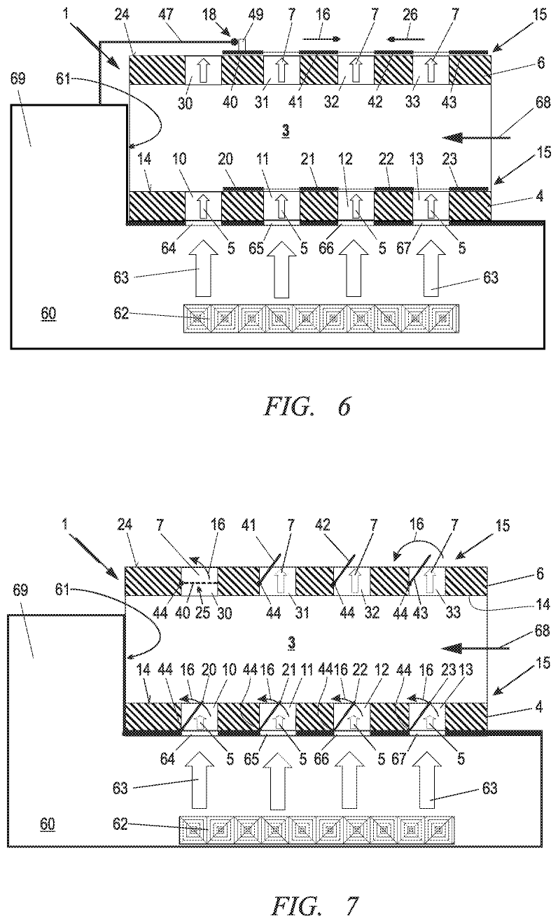

In FIGS. 6 and 7, a device 60 having a receptacle 61 for a battery pack 1 is schematically shown. The schematically illustrated device 60 can be a charger or also a power tool. A cooling fan 62 is provided in the device 60 and can serve to cool power electronics installed in the device 60, charging electronics, or also an electric consumer installed in the device 60, such as an electric motor. The cooling air flow 63 of the device 60 exits the housing 69 of the device 60 via at least one cooling-air outlet opening 64. In the exemplary embodiment shown, a plurality of cooling-air outlet openings 64, 65, 66 and 67 of the housing 69 of the device 60 open into a receptacle 61 for a battery pack 1. The battery pack 1 is inserted in the direction of arrow 68 into the receptacle 61 of the device 60 such that at least one ventilation opening 10 is connected to a cooling-air outlet opening 64, 65, 66 or 67. It can be expedient if, when the battery pack 1 is inserted into the receptacle 61, at least one ventilation opening 10, 11, 12 or 13 is at least partially aligned with one of the cooling-air outlet openings 64, 65, 66 or 67. As illustrated in FIGS. 6 and 7, the housing 69 of the device 60 has a plurality of, in particular four, cooling-air outlet openings 64, 65, 66 and 67. The in particular plurality of ventilation openings 10, 11, 12 and 13 of the housing 2 of the battery pack 1 are at least partially, preferably completely, aligned with the cooling-air outlet openings 64, 65, 66 and 67.

In FIG. 6, the closure elements 20, 21, 22, 23 are provided on the inner side 14 of the housing wall 4. The closure elements 20, 21, 22, 23 lie in the receiving space 3. An arrangement of the closure elements on the outer side 24 of a housing wall, for example the housing wall 6, can be expedient. The closure elements 40, 41, 42, 43 of the ventilation openings 30, 31, 32, 33 in the housing wall 6 lie on the outer side 24 of the housing 2 of the battery pack 1. The ventilation openings 30, 31, 32, 33 can advantageously open into the free environment of the device. This ensures good outflow of the air flows 7 exiting from the receiving space 3.

As the section through the battery pack 1 according to FIGS. 6 and 7 shows, a ventilation opening 30, 31, 32, 33 for the exit of the air flow 7 from the receiving space 3 can be assigned to a ventilation opening 10, 11, 12, 13 for the entry of an air flow 5 into the receiving space 3. The at least one ventilation opening 10, 11, 12, 13 in the housing wall 4 of the receiving space 3 is opposed by at least one ventilation opening 30, 31, 32, 33 in the opposite housing wall 6 of the receiving space 3. In each case, a ventilation opening 30, 31, 32, 33 for the exit of the air flow 7 from the receiving space 3 can be assigned to each ventilation opening 10, 11, 12, 13 for the entry of an air flow 5 into the receiving space 3. The ventilation opening 30, 31, 32, 33 assigned to a ventilation opening 10, 11, 12, 13 can lie directly opposite.

The device 60 can be provided with a means for adjusting the closure elements 40, 41, 42, 43 into their open position, which means can be formed as an actuating stop 47, in particular as a mechanical actuating stop 47. The mechanical actuating stop 47 cooperates with a counter-stop 49 of a closure element 40, 41, 42, 43 as an actuating device 18 that serves to adjust the closure elements 40, 41, 42, 43 and also the closure elements 20, 21, 22, 23. Thus, by means of the actuating device 18, on the one hand the closure elements 20, 21, 22, 23 of the ventilation openings 10, 11, 12, 13 in the housing wall 4 are shifted, in particular together, into the open position 15; the closure elements 40, 41, 42, 43 assigned to the ventilation openings 30, 31, 32, 33 in the housing wall 6 are also shifted by the actuating device 18 into the open position 15. When the battery pack 1 is inserted in the direction of arrow 68, the actuating stop 47 strikes the counter-stop 49, by way of which at least one closure element, preferably all closure elements together, is shifted. The reaction force of the mechanical actuating stop 47 generates the opening force 16 for adjusting the closure elements into the open position 15. In the fully inserted position of the battery pack 1 in the receptacle 61, the actuating stop 47, in cooperation with the counter-stop 49 and against a closing force 26, holds the closure elements 20, 21, 22, 23 and 40, 41, 42, 43 in the open position 15. If the battery pack 1 is removed from the receptacle 61 opposite the direction of arrow 68, the counter-stop 49 moves away from the actuating stop 47. The closing force 26 is no longer opposed by the actuating device 18, so that the closing force 26 moves the closure elements 20, 21, 22, 23 and 40, 41, 42, 43 into the closed position.

In the exemplary embodiment according to FIG. 7, the closure elements 20, 21, 22, 23 and 40, 41, 42 and 43 are formed as flaps or louver blades pivotable about an axis 44. As shown using the example of the housing wall 4, the axis 44 can lie at or near the outer side 24 of the housing wall 4. The axis 44 can also be provided at or near the inner side 14 of the housing wall 4. In particular, the axis 44 can lie between the inner side 14 of the housing wall and the outer side 24 of the housing wall, as shown by way of example in FIG. 7 on the housing wall 6.

The flap formed as the closure element 20, 21, 22, 23 or 40, 41, 42, 43 is spring-loaded into its closed position 25 and closes the assigned ventilation opening 10, 11, 12, 13 or 30, 31, 32 and 33. The means for adjusting the closure elements 20, 21, 22, 23 and 40, 41, 42, 43 into their open position 15 is provided by a cooling air flow 63 of the cooling fan 62 of the device 60. The actuating device 18 for moving the flaps uses the cooling air flow 63 of the device 60. The cooling air flow 63 itself forms the force source 19 for providing an opening force 16. When the battery pack is inserted into the receptacle 61, as illustrated in FIG. 6, the cooling air flow 63 exiting from the cooling-air outlet openings 64, 65, 66 and 67 opens the closure elements 20, 21, 22, 23 formed as flaps in the direction of the opening force 16, so that an air flow 5 can be used for temperature conditioning of the cell assembly 8 arranged in the receiving space 3. The air flow 5 entering the receiving space 3 produces a pressure build-up in the receiving space 3, which leads to opening of the closure elements 40, 41, 42 and 43 of the ventilation openings 30, 31, 32, 33 formed as flaps. The flaps are pivoted about their axis 44 in the direction of the opening force 16, so that an air flow 7 can exit from the ventilation openings 30, 31, 32 and 33.

As indicated by dashed lines in the upper left of FIG. 7, the closure element 40 formed as a flap lies sealingly in its closed position 25 in the ventilation opening 30, so that the latter is closed against entry of dirt. As soon as the cooling fan 62 is switched off, the cooling air flow 63 ceases and the closure elements formed as flaps are reset into their closed position 25. If, while a charging operation is running, the battery pack 1 is removed from the receptacle 61 opposite the direction of arrow 68, the air flow 5 entering the receiving space 3 ceases. The closure elements formed as flaps return to their closed position 25 and ensure that penetration of dirt is prevented during outdoor operation of the battery pack 1.

According to a method for charging and/or discharging a battery pack 1 according to one or more of the features described above using a device 60, the battery pack 1 is inserted in the direction of arrow 68 into a receptacle 61 of the device 60. To insert the battery pack 1, it is aligned with an actuating stop 47 of the device 60, which forms a means for adjusting the closure elements into their open position 15. Upon insertion of the battery pack 1 into the receptacle 61, the actuating stop 47 exerts a reaction force on a counter-stop 49 of a closure element. The reaction force occurring upon insertion adjusts the closure element into its open position 15. In the fully inserted position of the battery pack 1 in the receptacle 61 (illustration in FIG. 6), the actuating stop 47, via the counter-stop 49, holds the closure element and/or a plurality of closure elements in its/their open position 15.

According to a method for charging a battery pack according to one or more of the features described above using a device that comprises a cooling fan 62 for a cooling air flow 63, the battery pack 1 is inserted into the receptacle 61 of the device 60 such that at least one ventilation opening 10, 11, 12, 13 of the battery pack 1 is connected to a cooling-air outlet opening 64, 65, 66, 67 of the device 60, or is at least partially aligned therewith. The cooling air flow 63 supplied or discharged via the cooling-air outlet opening 64, 65, 66, 67 of the device 60 serves as a force source 19 of an actuating device 18 in order to exert an opening force 16 on the closure element or the closure elements of the ventilation opening or of the ventilation openings and to move them into the open position 15. Over at least part of the charging time of the battery pack 1, the cooling air flow 63 holds open the ventilation opening or the ventilation openings 10, 11, 12, 13 and 30, 31, 32, 33.

According to a further method for charging and/or discharging a battery pack 1 having one or more of the features described above using a device 60, the battery pack 1 is inserted into the receptacle 61 of the device 60 and to monitor the temperature of the cell assembly 8 during the charging operation. When a limit temperature is undershot, the closure element 20, 21, 22, 23 and/or 40, 41, 42, 43 is moved into the closed position 25 and the ventilation opening 10, 11, 12, 13 and/or 30, 31, 32, 33 is closed. When the limit temperature is exceeded, the closure element 20, 21, 22, 23 and/or 40, 41, 42, 43 is moved into the open position 15 and the ventilation opening 10, 11, 12, 13 and/or 30, 31, 32, 33 is opened.

1.-12. (canceled)

13. A battery pack comprising:
a receiving space bounded by a housing wall;
a cell assembly including individual cells received in the receiving space;
a ventilation opening formed in the housing wall for entry and/or exit of an air flow for temperature conditioning of the cell assembly; and
a closure element associated with the ventilation opening,
wherein the closure element, in a closed position, closes the ventilation opening to block entry and/or exit of the air flow and, in an open position, opens the ventilation opening to allow entry and/or exit of the air flow.

14. The battery pack according to claim 13,
wherein the closure element is biased by a spring force toward the closed position.

15. The battery pack according to claim 13,
further comprising a further ventilation opening formed in the housing wall for entry and/or exit of a further air flow,
wherein the closure element is associated with the further ventilation opening, and
wherein the closure element, in the closed position, closes the further ventilation opening to block entry and/or exit of the further air flow through the further ventilation opening, and, in the open position, opens the further ventilation opening to allow entry and/or exit of the further air flow through the further ventilation opening.

16. The battery pack according to claim 13,
wherein the closure element is a slider, a flap pivotable about an axis, a shutter, or a louver.

17. The battery pack according to claim 13,
wherein the closure element is arranged on an inner side of the housing wall.

18. The battery pack according to claim 13,
further comprising an actuating device including a force source for providing an actuating force,
wherein the actuating device is configured to move the closure element into the open position with the actuating force.

19. The battery pack according to claim 18,
wherein the force source is a temperature element or is coupled to a temperature element, and
wherein the force source is configured to exert a closing force on the closure element when a temperature falls below a limit temperature and to exert an opening force on the closure element when the temperature exceeds the limit temperature.

20. The battery pack according to claim 13,
wherein the ventilation opening is configured for entry of the air flow, and
wherein a further ventilation opening is arranged opposite the ventilation opening.

21. A device for charging and/or discharging the battery pack according to claim 13, the device comprising:
a receptacle configured to receive the battery pack; and
an actuating mechanism configured to move the closure element into the open position.

22. The device according to claim 21,
wherein the actuating mechanism comprises an actuating stop, and
wherein the actuating stop holds the closure element in the open position.

23. A method comprising:
providing a battery pack comprising
a receiving space bounded by a housing wall,
a cell assembly including individual cells received in the receiving space,
a ventilation opening formed in the housing wall for entry and/or exit of an air flow for temperature conditioning of the cell assembly, and
a closure element associated with the ventilation opening,
wherein the closure element, in a closed position, closes the ventilation opening to block entry and/or exit of the air flow and, in an open position, opens the ventilation opening to allow entry and/or exit of the air flow;
providing a device comprising
a receptacle configured to receive the battery pack, and
a cooling fan configured to generate a cooling air flow that is supplied or discharged through cooling-air outlet openings of the device;
inserting the battery pack into the receptacle of the device such that a ventilation opening of the battery pack is at least partially aligned with a cooling-air outlet opening of the device;
supplying or discharging the cooling air flow through the cooling-air outlet opening of the device;
exerting, by the cooling air flow acting as a force source, an actuating force on the closure element of the ventilation opening;
moving the closure element into the open position; and
holding the ventilation opening open with the cooling air flow over at least part of a charging time and/or discharging time of the battery pack.

24. The method according to claim 23, further comprising:
monitoring a temperature of the cell assembly during charging and/or discharging;
closing the ventilation opening with the closure element when the temperature falls below a limit temperature; and
opening the ventilation opening with the closure element when the temperature exceeds the limit temperature.
